(19) United States
(12) Patent Application Publication
(10) Pub. No.: US 2004/0246605 A1
(43) Pub. Date: Dec. 9, 2004

(54) Poly-conical reflectors for collecting, concentrating, and projecting light rays

(76) Inventors: Michael R. Stiles, Syracuse, NY (US); Daniel M. Fuller, Syracuse, NY (US)

Correspondence Address: BOND, SCHOENECK & KING, PLLC, ONE LINCOLN CENTER, SYRACUSE, NY, 13202-1355, US

(21) Appl. No.: 10/793,448

(22) Filed: Mar. 4, 2004

Related U.S. Application Data
(60) Provisional application No. 60/451,403, filed on Mar. 4, 2003.

(51) Int. Cl. G02B 21/00

(52) U.S. Cl. 359/857; 359/529

(57) ABSTRACT

A collector for concentrating light rays including a first conical segment having an inner reflective surface joined to or nested within a second conical segment having an inner reflective surface. A first embodiment consists of stacked reflective segments, where the upper conical segment is slightly diverging and the lower conical segment is converging in the direction of an input light ray. A second embodiment comprises an outer conical segment that converges in the direction of an input light ray and a nested inner conical segment that also converges in the direction of a light ray. In either embodiment, the present invention is capable of concentrating more energy when not aimed directly at an energy source than single cone collectors and thus simplifies the source tracking strategy.

### CROSS REFERENCES TO RELATED APPLICATIONS

The present application claims priority to U.S. Provisional Application Ser. No. 60/451,403 of the same title, filed on Mar. 4, 2003, and hereby incorporated by reference.

### BACKGROUND OF THE INVENTION

1. Field of Invention

The present invention relates to optical structures and methods for collecting and utilizing beams of light and, more specifically, to devices for the collection and concentration of beam sunlight for its conversion to electricity, heat, or lighting.

2. Description of Prior Art

The conical or funnel-shaped collection structure was known and patented in the nineteenth century for the practice of delivering natural light to the interior of buildings (see, e.g., U.S. Pat. Nos. 550,376, 585,770, and 668,404). The optical principles are simple. The larger of two apertures of a truncated cone points substantially towards the sky, collecting daylight. The smaller of the two apertures receives the collected light in concentrated form and releases it to a distribution system or other means for delivering it to the interior of a structure, such as a building. Conically shaped reflectors have a wide angle of acceptance of solar rays, typically over tens of degrees away from the principal optic axis. This feature contrasts with focusing types of concentrators like lenses and parabolic focus reflectors, which must be pointed at the sun to within a few degrees. A recent version of this optical structure has merely improved on the mounting and interface means for the truncated cone, see e.g., U.S. Pat. No. 5,648,873.

Applications for the collection of sunlight may take one of two forms. The first is stationary, whereby the optical structures do not move over time. The second form tracks the apparent trajectory of the sun to maximize the collection of available solar power. The simplest of these structures remains stationary over time. One strategy uses a non-moving funnel-shaped collection structure, see, e.g., U.S. Pat. No. 4,052,976, but introduces the complication of a concentrated area of light that moves over time instead of aiming at a constant target aperture. U.S. Pat. No. 4,267,824 is directed to an inflatable conical structure, which merely makes the concentrating truncated cone provide light into a portable device.

Other conical structures have good collection characteristics, but suffer from other complications. U.S. Pat. Nos. 4,266,858, 4,337,758, and 5,174,275 disclose conical segments in their optical networks but require axially elongated target regions instead of a simple fixed exit aperture for concentrated rays. In other inventions, a conical structure is a secondary element in an optical network, such as in U.S. Pat. No. 5,460,659.

Another strategy for collecting light is based on a plurality of conical collectors, see, e.g., U.S. Pat. No. 4,309,079. These collectors are arranged in a semicircular fashion to receive the rays of the sun across its arc of trajectory. In the first embodiment, each conical collector has its own means of receiving concentrated solar radiation. In the second embodiment, the conical structures comprise a single collector. These embodiments do not take advantage of economy of scales, however, whereby a small number of cones may be combined to collect sunlight over an angular range greater than that of a single cone. The disclosed means for receiving concentrated sunlight are also not easy to interface to a distribution system like a reflective duct.

There have been many inventions that actively point an optical network at the sun to enhance its collection capabilities. An example is U.S. Pat. No. 4,590,920, in which a conical reflector is found to be but a secondary element in an apparatus that tracks the sun.

U.S. Pat. Nos. 4,080,221 and 4,223,174 teach the greatest economy and simplicity of implementation, but are limited to a truncated conical structure in its simplest form. The latter patent merely proposes an optical enhancement to the basic cone.

3. Objects and Advantages

It is a principal object and advantage of the present invention to widen the angle of acceptance of a collector.

It is an additional object and advantage of the present invention to extend the number of useful hours of daily operation of a collector.

It is a further object and advantage of the present invention to reduce the accuracy and cost needed for the mechanical tracking of the motion of the sun while providing maximal collection of available power.

It is an additional object and advantage of the present invention to provide lens-less projection of rays along selected angles.

Other objects and advantages of the present invention will in part be obvious, and in part appear hereinafter.

### SUMMARY OF THE INVENTION

The present invention comprises variations on a conical reflector for use in three different types of applications. In one embodiment, the collector comprises an upper segment having a reflective interior surface connected to a lower segment having a reflective interior surface along a common juncture, where the upper and lower segments taper away from said juncture to corresponding entrance and exit apertures. In other embodiment, the collector comprises an inner segment having a reflective interior surface and a reflective exterior surface that is surrounded by a first outer segment having a reflective interior surface and a second outer segment having a reflective interior surface connected to said first outer segment and positioned around said inner segment, where all segments taper toward said exit aperture.

The first application of the present invention is for the collection and utilization of sunlight for conversion to electricity or heat. The second application collects sunlight for the illumination of buildings. The third application uses conical reflectors as a means for projecting the rays of various lighting sources. The present invention accomplishes the third application by placing the source or radiant light or energy at the smaller aperture of an enhanced conical reflector that selectively releases rays through its larger aperture. Applications for the present invention include novelty, merchandise display, and theatrical lighting fixtures.

### BRIEF DESCRIPTION OF THE DRAWINGS

FIG. 1 is a schematic representation of the path of light rays in a prior art collector having a reflective interior.

FIG. 2 is a schematic representation of the path of light rays in another prior art collector having a reflective interior.

FIG. 3 is a schematic representation of the path of light rays in a collector according to the present invention.

FIGS. 4A and 4B are cross-sectional diagrams of a collector according to the present invention.

FIG. 5 is a cross-sectional diagram of an alternate embodiment of a collector according to the present invention.

FIG. 6 is a diagram of a test performed on a collector according to the present invention.

FIG. 7 is a chart of the results of a test performed on a collector according to the present invention.

FIG. 8 is perspective view of an alternate embodiment of a collector according to the present invention.

FIG. 9A is a top view of an alternate embodiment of a collector according to the present invention.

FIG. 9B is a cross-sectional view of an alternate embodiment of a collector according to the present invention.

FIG. 9C is a schematic representation of an alternate embodiment of a collector according to the present invention.

FIG. 10 is a cross-sectional, side view of a system including collectors according to the present invention.

### DETAILED DESCRIPTION

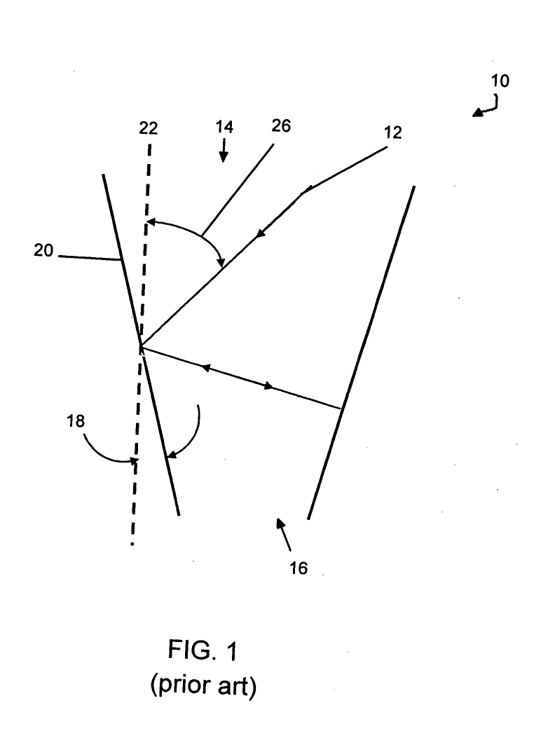

Referring now to the drawings wherein like numerals refer to like parts throughout, there is seen in FIG. 1 a diagram of longitudinal cross-section of a prior art collector 10 comprising a truncated cone having a reflective interior. An input light ray 12 enters the top of collector 10 through an entrance aperture 14, a portion of which is reflected through collector 10 and exits from a bottom aperture 16. A target that makes use of the concentrated light, such as a photovoltaic cell (PV) may be placed below bottom aperture 16.

There are several key design parameters for collector 10. A first parameter is the size of the target device, such as a photovoltaic (PV) cell, which determines the cross-sectional extent of bottom aperture 16. A second parameter is the desired concentration ratio, which is one factor in specifying the cross-sectional extent of entrance aperture 14. A third parameter is the vertical height of collector 10. These parameters help define the requisite cone angle 18, seen in FIG. 1 as the angle between the wall 20 that forms the cone of collector 10 and vertical reference axis 22. Vertical reference axis 22 is parallel to the central longitudinal axis, or the optic axis, of collector 10.

There are at least two limiting conditions for collecting and concentrating light rays through a conical collector 10. For a given cone angle 18, referred to as α_{cone}, there are orientations of input rays 12 that, upon a second reflection, will reflect back out through entrance aperture 14. The angle of input ray 12 at which reflection back begins is defined as α_{reject} and seen in FIG. 1 as angle 26. The relationship between these two angles is:

α_{reject}=−3α_{cone}+90°, 0<α_{reject}<90° (Equation 1)

The second limiting condition occurs for input rays 12 that reflect too many times through the cone of collector 10 of a given vertical height. Such rays 12 will eventually reflect back through the entrance aperture 14. For solar optic applications, these limiting conditions influence both the instantaneous power output and the ongoing energy production from collector 10 of a given size, cone angle 18, and orientation relative to the apparent trajectory of the sun.

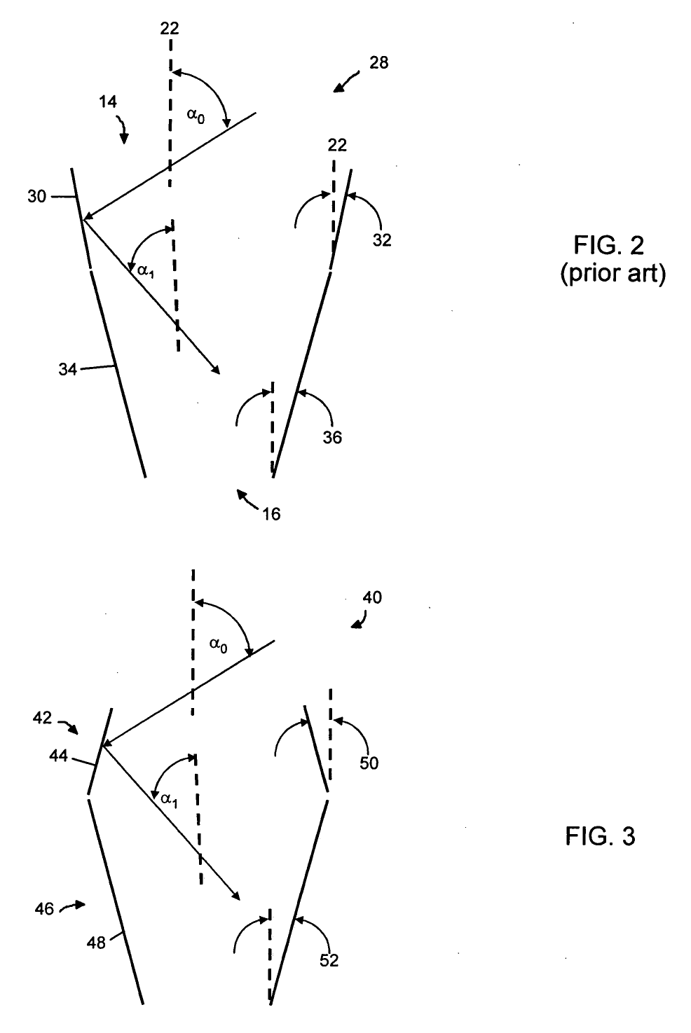

As seen in FIG. 2, attempts to overcome these deficiencies in a prior art cone 28 include the introduction of an addition of upper conical segment 30 to entrance aperture 14. Upper segment 30 defines an upper wall angle 32 relative to vertical reference axis 22 that is in the preferred range of 9°-11°. A lower conical segment 34 forms a lower wall angle 36 in the preferred range of 13°-17°. Additional conical segment 30 collects parallel, spatially adjacent rays after first reflection and transports them via vertical displacements to avoid the problem of too many reflections that will ultimately reject the rays, thus only the second limiting condition described above.

As shown in FIG. 2, collector 28 does not extend the useful range of input rays 12. Input rays 12 strike the upper conical wall segment at an input angle α₀ and have a first reflection at an angle α₁ relative to vertical reference axis 22. Assuming an upper conical wall angle 30 of 10°, the relationship between the two angles is quantified in the first two columns of Table 1.

TABLE 1

| α₀ (in degrees) | α₁ (in degrees). |
|---|---|
| 30 | 50 |
| 35 | 55 |
| 40 | 60 |
| 45 | 65 |
| 50 | 70 |

If lower conical wall angle 36 is about 15°, the geometry shown in FIG. 2 will not enhance the range of collectable angles. The reflected rays in the selected range are greater than 45° and are therefore rejected by lower conical segment 34.

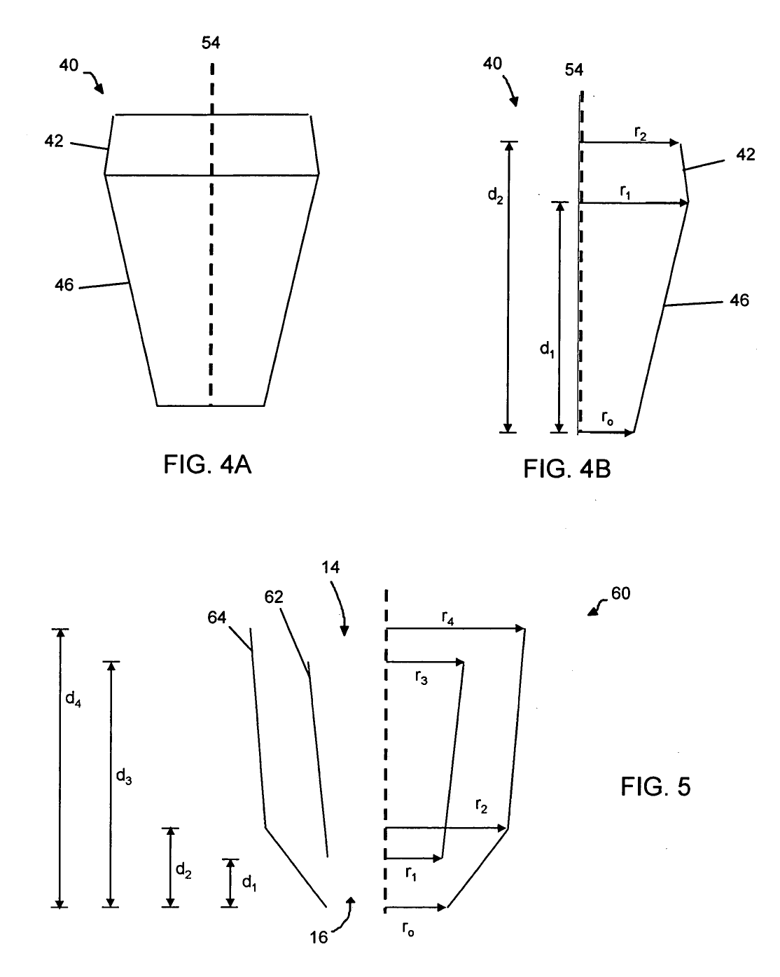

Referring now to FIG. 3, one embodiment of the present invention comprises double conical collector 40 having an upper conical segment 42 defined by an upper cone wall 44 having a slope in the opposite sense of a lower conical segment 46 defined by a lower cone wall 48. Referring to FIGS. 4A and 4B, the upper and lower segments 42 and 46, respectively, are positioned in a stacked arrangement along optic axis 54 and connected structurally along a common juncture.

If the upper and lower angles 50 and 52 formed by upper and lower walls 44 and 48, respectively, are at angles of 15° on either side of vertical reference axis 22, input and output ray angles α₀ and α₁, will be listed in Table 2.

TABLE 2

| α₀ (in degrees) | α₁ (in degrees). |
|---|---|
| 30 | 0 |
| 35 | 5 |
| 40 | 10 |
| 45 | 15 |
| 50 | 20 |

Upper conical segment 42 therefore extends the range of useful angles (<45°) for double conical collector 40 well beyond that collectors 10 and 28 shown in FIGS. 1 and 2, respectively.

The embodiment of the present invention shown in FIG. 3 may be modified to mimic the functionality of prior art collector 28. Table 3 below lists the input and output ray angles α₀ and α₁, respectively, if upper wall angle 44 is 10°. Output rays reflected from upper conical segment 42 become less slanted for lower segment 46. This effect enhances the ray collection capabilities of the present invention below the limiting case of 45°. As a result, the preferred embodiment of the present invention improves the ray-passing capabilities of a three-dimensional structure.

TABLE 3

| α₀ (in degrees) | α₁ (in degrees). |
|---|---|
| 20 | 0 |
| 25 | 5 |
| 30 | 10 |
| 35 | 15 |
| 40 | 20 |

As seen in FIG. 5, another embodiment of the present invention comprises double cone segments arranged into a nested collector 60 having separate inner and outer cones 62 and 64, respectively, supported in the nested configuration by way of thin struts (not shown) or other supports that do not shadow a substantial portion of the rays passing through. Alternatively, nested collector 60 may have interior partitions that reflect light.

With regard to either stacked collector 40 or nested collector 60, there is a common entrance aperture 14 for all input rays 12. There is also a common exit aperture 16 for input rays 12 passing through and impact a target device, such as a PV. As seen in FIGS. 4B and 5, the geometry of stacked collector 40 or nested collector 60 can be expressed by radii, rᵢ, defining the distance from optic axis 54 to the edge of a given segment of cone a corresponding number of separation distances, dᵢ, or heights. The radius of common exit aperture 16 may be defined as r₀, and all successive radii are numbered sequentially therefrom. Nests of simple truncated cones may be also described as a list of rᵢ and dᵢ. As seen in FIG. 5, it is necessary to designate which of the rᵢ are associated with each other in a given conical segment. Further refinement of these conventions need not be pursued further and will be understood by those skilled in geometrical optics.

The innermost cone of nested collected 60 may be reflective on both sides to facilitate the passage of rays collected between radii r₃ and r₄. Curved segments may be defined as functions of the form rᵢ=rᵢ(dₐ,d_{b}), where d_{b}>dₐ in a range beginning at dₐ and ending at d_{b}.

The advantage of the poly-conical configurations of the present invention is that input rays 14 of orientations that are rejected in one part of collector 40 or 60 may be re-collected or passed independently through the optical system by another location.

The poly-conical configuration of the present invention includes a few limits and trade-offs in order to optimize collection capabilities. For example, the upper portions of collector 40 and 60 may cast shadows across common exit aperture 16 at certain input ray 12 orientations. This problem may be partially solved by using transparent sections of upper or inner segments 42 or 62 respectively.

Injudicious placement of changes in radius may result in light traps within the optical system. There are diminishing returns to an increase in collectors, as increasing the number of collectors 40 or 60 beyond a certain limit will produce no angular or other advantages and will degrade overall system performance.

Collectors 40 or 60 may reflect light at least two physical mechanisms. One is by the use of a specular reflecting surface. The second is by Fresnel reflectivity of a transparent material supplied as the reflecting surface. The latter occurs when rays almost parallel to the structure's surface glance off with very little transmission through it. This may be readily envisioned for the top section of stacked collector 40 in FIG. 3. The advantage of a transparent upper section 42 is that it does not impede diffuse rays from entering the optical system under hazy sky conditions.

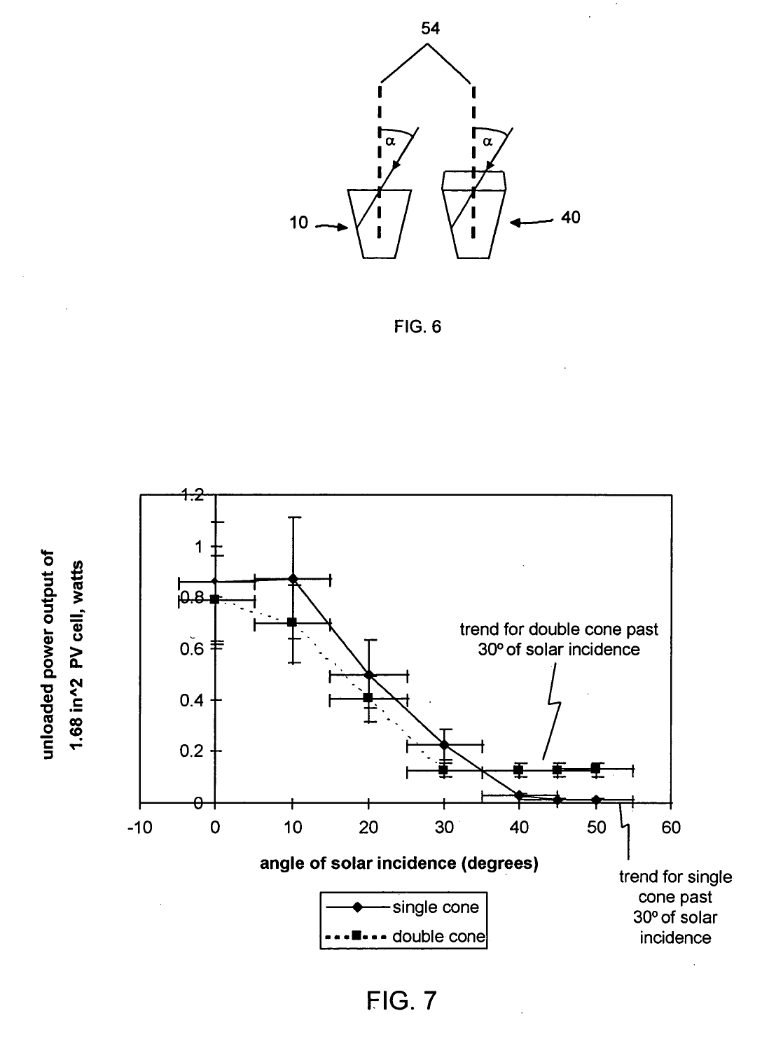

As seen in FIGS. 6 and 7, a test comparison between a prior art, single cone collector 10 and double cone collector 40 of the present invention yielded favorable results. Collector 40 made from silver mylar, cardboard frustrum templates, and ad hoc fastening techniques having specification of r₀=1 inch, r₁=2.5 inches, r₂=2 inches; d₁=5 inches, d₂=7.5 inches was compared to a prior art collector 10 lacking upper segment 42. The entire inner surfaces of both segments were covered with reflective mylar. A target 1.4×1.2 in² buried contact photovoltaic (PV) cell obtained from the University of New South Wales, Australia target was positioned under exit aperture 16. The area of the PV cell was thus 1.68 in² (0.011667 ft², 10.83869 cm², or 0.001084 m²) and fit within the circular boundary of the common exit aperture. The PV cell's solid-state construction allowed it to increase output power in direct proportion to level of concentration of sunlight up to a concentration ratio of at least 10×. Thus, concentrating sunlight optically onto the cell by 2× doubles its power output compared with un-concentrated sunlight.

FIG. 7 is a plot of the unloaded output power as a function of solar input angle for the single and double collectors, 10 and 40, respectively. In the conventions of the solar energy industry, unloaded power is a rating for PV performance and is a function of open circuit voltage and short-circuit current. Open circuit voltage is measured when a volt-meter is the only electrical device across the PV cell terminals. Short-circuit current is measured when an ammeter of sufficiently low internal impedance is the only device across the cell's terminals. The unloaded output power is then taken as the product of the open circuit voltage and the short-circuit current. The results, expressed in units of watts, are plotted in FIG. 7 with their estimates of measurement precision shown as error bars.

The graph in FIG. 7 shows that from 0° to 30° of solar input angle, the power output of the prior art collector 10 was slightly higher than that of the double cone (although the data is within mutual measurement error). This is expected due to the slight shading of input aperture 14 by the opaque regions of upper segment 42 of the double cone collector 40. The most noteworthy difference appeared in the range of angular incidence from 30°-50°. As the graph in FIG. 7 shows, the PV cell's power output under single cone 10 vanishes in that range. Over the same range, however, the power output under double cone collector 40 remains constant at a significant level. The double cone collector 40 thus extends the useful range of solar input.

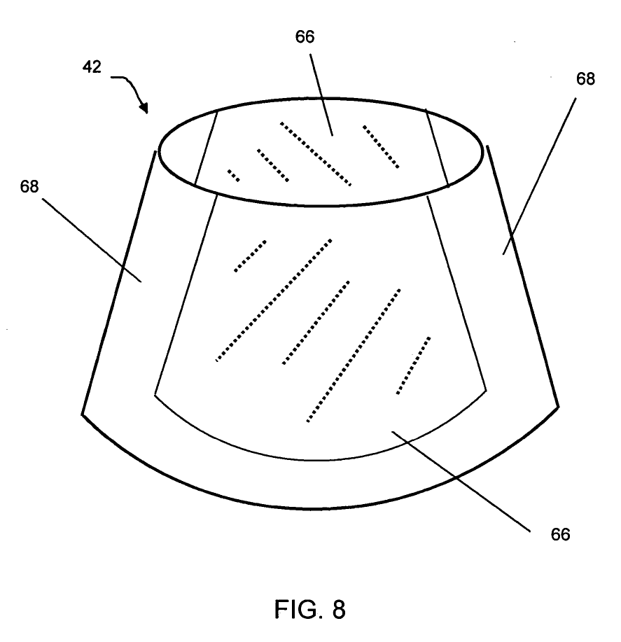

Referring to FIG. 8, there is seen an alternate embodiment of upper segment 42. Transparent areas 66 are provided to reduce the shading effects when solar incidence is in the range of 0°-30°. These light-admitting areas 66 may also be simple cut-outs of the material comprising upper conical segment 42. Opaque regions 68 with reflective inner linings are on the eastern and western “wings” of upper segment 42. The reflective wing region 68 collect light when the sun is at its eastern and western extremes of trajectory relative to entrance aperture 14 of collector 40.

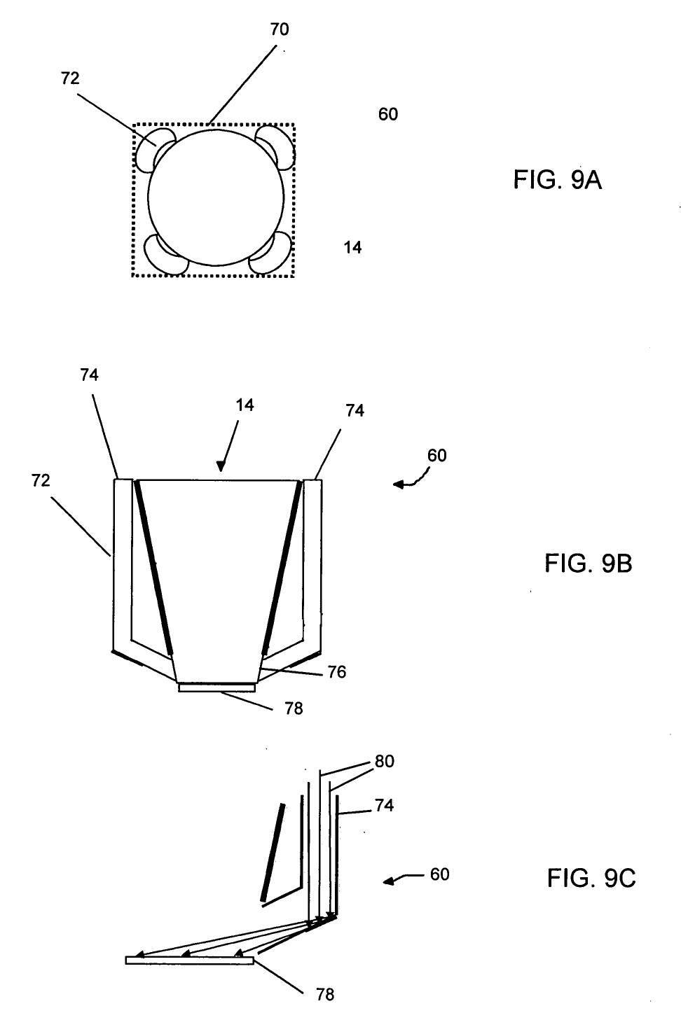

Another embodiment of the present invention for increasing the amount of luminous power delivered to the exit aperture when multiple prior art conical collectors 10 are positioned in an array is seen in FIG. 9A-9C. As seen in FIG. 9A, entrance aperture 14 is substantially circular and creates square region 70 when a plurality of collectors 10 are placed side-by-side in an array, circular entrance apertures 14. Light-collecting structures 72 in the corners of nearest-neighbor squares 70 make use of space that is normally unused in optical collecting devices. As seen in FIGS. 9B and 9C, light collected from the corners is piped by substantially vertical guides 74 from nearby entrance aperture 14 to nearby exit aperture 16. As seen in FIG. 9B, light guides 74 terminate near a light-transmissive section 76 where the sidewall silvering ends near the bottom of collector 40. The light in guides 74 is then preferentially released onto a PV cell 78 positioned at the bottom of collector 40.

Light guides 74 depicted in FIGS. 9A-9C may operate by the principles of total internal reflection or by specular reflection. As FIG. 9C shows, input rays 80 released from light guides 74 are obliquely disposed onto a PV cell 78. This embodiment requires a PV cell 78 that can accept rays 80 at such angles. One example is the PV cell available from the University of New South Wales used to generate the data contained in FIG. 7.

The minimum combination of this embodiment consists of a simple conical collector 10 and light guides 74. Light guides 74 provide more luminous power to exit aperture 16 than collector 10 would otherwise, especially at ray angles near zero degrees. When light guides 74 are used with stacked and nested collectors 40 and 60, respectively, light guides 74 compensate for loss of power due to shadowing effects.

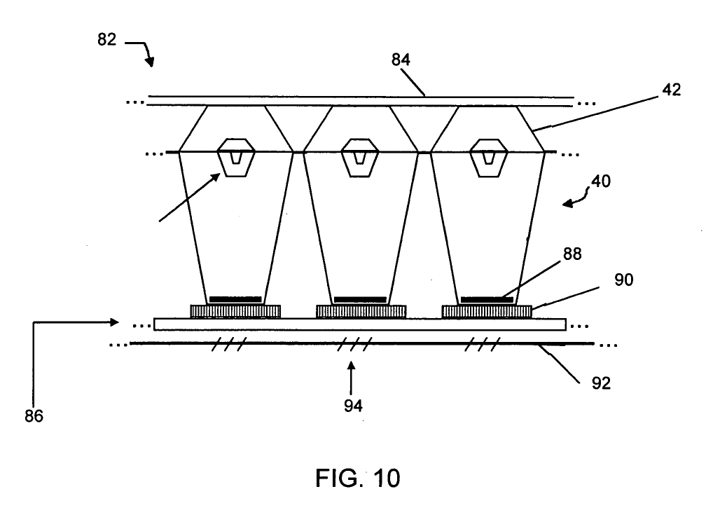

There is seen in FIG. 10 a standard commercial panel unit 82 in the solar electric industry is a panel-like package that holds, supports, encloses, positions, and protects the working components and allows for easy installation. Panel 82 includes a weatherproof cover 84 above collectors 40 and may be glued, epoxied, caulked, or otherwise adhered to upper segments 42. If two or more collectors 40 are included in each panel 82, a structural support member 86 may be provided for securing them together. A screw-in holder, glue, epoxy, caulk, or other similar attachment method may attach a PV cell 88 to exit aperture 16 of each optical unit 82. The bottom of individual collectors 40 should be at some minimum distance from whatever supports 86 to protect the PV assemblies 88 during installation and to help absorb mechanical perturbations should panel 82 be dropped.

To preserve the optical integrity of the system, a water-tight seal must be maintained at the transparent cover, across all junctures of segments in the optical units, and whatever device occupies the common exit aperture of each unit. In the case of PV cells 88, a heat sink 90 should be in good thermal contact to draw away the unwanted effects of optical concentration. A more complicated panel structure may employ a circulating fluid to collect the excess heat for use with a thermal application. Panel 82 may also include protective sheathing 92 having ventilation apertures 94. If PV cells 88 are to be wired in series, a common practice for achieving industry-standard output voltages, structural support members 86 must electrically isolate heat sinks 90 from each other. Members 86 may be supplied in the form of struts that link to form a supportive lattice on the underside of the panel.

As certain implementations require the protection of the optics from moisture, dust, and vermin infestations, individual upper segments 42 should be sealed to a transparent cover. In embodiments that include a PV cell 88, the cell should be on a heat sink 90 sealed to exit aperture 16. In solar lighting implementations in which entrance apertures 14 are exposed to the atmosphere, a transparent cover 84 should be used to seal the opening into the building or other structure must be provided. Reflective optics above this transparent cover 86 may be cleaned by rain or by washing, in which case weep holes should be provided along the perimeter between the conical structures and the transparent barrier to the interior of the building. Alternatively, a transparent dome can enclose the entire structure and its penetration into a building.

If the optic axes of collectors 40 or 60 can be kept within about 20° of aiming straight at the sun, the major benefits of optical concentration will occur. For applications where a plurality of optical panels 82 track the sun, energy output increases with increasing frequency of change in panel orientation. This situation may be controlled by something as simple as a timer set for the requirements of a given geological latitude of installation and thus does not require sensors, comparator and control logic, and continuously variable mechanical positioning devices required by prior art systems.

Each of the optical configurations of the present invention may be combined with an appropriate mounting and positioning strategy to define specific commercial products. For electrical peak demand reduction where a panel-like structure is preferred, the stacked or nested configuration may be used, with some portion of the upper or interior conical segment(s) 42 and 62, respectively, oriented to face west or southwest in a stationary structure. The mounting means may be onto the side of a building, or on panel-supporting means with the orientation of panel 82 about the vertical tilt axis defined by construction or fixed permanently at installation. One such embodiment is for stationary PV panels mounted facing an advantageous direction for the purpose of augmenting the electric power supply during certain times of the year. One example is during summer months when the demand for electricity reaches a maximum due to increased loads imposed by air conditioning. This application of PV technology is called peak demand reduction in the field of electric utility services.

On-site installations where a panel-like structure is preferred, as in many residential and commercial applications, either the stacked or nested configuration may be used, with some portion of the upper or interior conical segments(s) 42 or 62, respectively, transparent and mounted with one axis of freedom. To obtain the maximum energy production throughout a year, the vertical tilt angle of panels 82 may be adjusted periodically over weeks or months as the seasons change. This may be accomplished manually or via a pre-set control timer and means for mechanical actuation.

Lighting applications, where collected and concentrated sunlight enters an interior lighting fixture through the wall or roof of a building, may use any of the embodiments of the present invention mounted to a weatherproof interface with a light-conveying means, such as a reflective duct or channel through the building envelope.

Lighting displays with beams directed along selected directions may use any of the configurations, with a source of light placed at the smaller of the two apertures of the system of elements, and the larger of the two apertures pointed towards one or more objects on display. If mounted on a means for providing motion, these fixtures may track an object, such as an actor on a stage, or may serially illuminate a number of objects in a collection as during a sales presentation.

What is claimed is:

1. A light collector, comprising:
an upper segment having a reflective interior surface;
a lower segment having a reflective interior surface connected to said upper segment along a common juncture; and
wherein said upper and lower segments taper away from said juncture.

2. The light collector of claim 1, wherein said upper segment defines an entrance aperture for allowing light to enter said collector.

3. The light collector of claim 2, wherein said lower segment defines an exit aperture for allowing light to exit said collector.

4. The light collector of claim 3, further comprising a heat-sinked photovoltaic cell positioned in said exit aperture.

5. The light collector of claim 1, wherein said light collector extends along a longitudinal axis.

6. The light collector of claim 5, wherein said upper segment extends along an angle of between 0 and 20 degrees relative to said longitudinal axis.

7. The light collector of claim 6, wherein said lower segment extends along an angle of between 10 to 20 degrees relative to said longitudinal axis.

8. The light collector of claim 7, wherein said upper and lower segments extend uniformly along said longitudinal axis.

9. The light collector of claim 1, wherein at least a portion of said upper segment is transparent.

10. The light collector of claim 1, wherein said upper and lower segments are frustroconical.

11. The light collector of claim 1, wherein said upper and lower segments are polygonal.

12. The light collector of claim 1, further comprising at least one light collecting structure including a light guide for transmitting light rays from adjacent to said upper segment to adjacent said lower segment.

13. A light collector having an entrance aperture and an exit aperture, said light collector comprising:
an inner segment having a reflective interior surface and a reflective exterior surface;
a first outer segment having a reflective interior surface positioned around said first segment;
a second outer segment having a reflective interior surface connected to said first outer segment and positioned around said inner segment; and
wherein said inner segment, said first outer segment, and said second outer segment taper toward said exit aperture.

14. The light collector of claim 13, wherein said inner segment, said first outer segment, and said second outer segment extend along a common longitudinal axis.

15. The light collector of claim 13, wherein said first outer segment defines said entrance aperture.

16. The light collector of claim 15, wherein said second outer segment defines said exit aperture.

17. The light collector of claim 16, wherein said inner segment defines an inner entrance aperture positioned within said entrance aperture and an inner exit aperture positioned proximate to said exit aperture.

18. The light collector of claim 17, wherein said inner segment is positioned within said first and second outer segments so that light reflected by said first and second outer segments may reach said exit aperture.

19. The light collector of claim 13, wherein said inner segment, said first outer segment, and said second outer segment extend along a common longitudinal axis.

20. The light collector of claim 13, wherein said inner segment, said first outer segment, and said second outer segment are frustroconical.

21. The light collector of claim 13, wherein said inner segment, said first outer segment, and said second outer segment are polygonal.

22. A light collecting panel, comprising:
a support member;
at least one collector including an entrance aperture and an exit aperture mounted to said support member, said collector comprising:
an upper segment having a reflective interior;
a lower segment having a reflective interior connected to said upper segment along a common juncture; and
wherein said upper and lower segments taper away from said juncture
a photovoltaic cell positioned in said exit aperture;
a heat sink connected to said photovoltaic cell; and
a transparent cover positioned over said entrance aperture.

23. The panel of claim 22, further comprising at least one light collecting structure including a light guide for transmitting light rays from adjacent to said upper segment to adjacent said lower segment.

24. The panel of claim 23, further comprising a plurality of said collectors arranged in an array, wherein a plurality of said light collecting structures are positioned between said collectors.

25. The panel of claim 22, wherein said panel is adapted to track the movement of the sun along at least one axis.

26. A light collecting panel, comprising:
a support member;
at least one collector including an entrance aperture and an exit aperture mounted to said support member, said collector comprising:
an inner segment having a reflective interior surface and a reflective exterior surface;
a first outer segment having a reflective interior surface positioned around said first segment;
a second outer segment having a reflective interior surface connected to said first outer segment and positioned around said inner segment; and
wherein said inner segment, said first outer segment, and said second outer segment taper toward said exit aperture;
a heat sink connected to said photovoltaic cell; and
a transparent cover positioned over said entrance aperture.

27. The panel of claim 26, further comprising at least one light collecting structure including a light guide for transmitting light rays from adjacent to said upper segment to adjacent said lower segment.

28. The panel of claim 27, further comprising a plurality of said collectors arranged in an array, wherein a plurality of said light collecting structures are positioned between said collectors.

29. The panel of claim 26, wherein said panel is adapted to track the movement of the sun along at least one axis.
